(19) United States
(12) Patent Application Publication
(10) Pub. No.: US 2016/0185370 A1
(43) Pub. Date: Jun. 30, 2016

(54) Body-Tow Pull-Cart Handle

(71) Applicant: Stephen Tracy Noyes, Boise, ID (US)

(72) Inventor: Stephen Tracy Noyes, Boise, ID (US)

(21) Appl. No.: 14/588,714

(22) Filed: Jan. 2, 2015

Related U.S. Application Data
(60) Provisional application No. 62/097,792, filed on Dec. 30, 2014.

(51) Int. Cl. B62B 1/24

(52) U.S. Cl. CPC B62B 1/24

(57) ABSTRACT

Apparatus consisting of a large hooked shaped frame, guide handle bar, and flexible strap from the left side to the right side of the hooked frame. The apparatus is used to transmit forward motion from the user to a pull-cart through his/her waist when walking within the hooked frame. The apparatus may include a mechanical joint that is to be attached to an existing pull-cart, or integrated into the design of a pull-cart.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

1. Field of the Invention

This invention allows a person to “tow” a pull-cart and various loads (such as golf clubs or mail bags) using primarily forces from their legs and pelvis. This new towing method virtually eliminates the compression and torsional rotation of the user's spinal column that is caused by the weight of a pull cart that is being towed with one hand. The force due to the weight of the pull-cart and the user's towing motion using one hand is transmitted through the muscles and joints in the user's hand, wrist, arm, shoulder, abdominal muscles and back. This invention allows a drastic reduction of these forces that strain the upper body thereby reducing fatigue, which negatively affects the user's performance in other tasks, and can also reduce pain and advancement of muscular and skeletal conditions.

2. Description of the Related Art

Past designs that have intended to address the strain that pulling a pull-cart causes to the upper body, have done so through various mechanical connections to a belt worn by the user, or by some other device that connects to the user or user's clothing. These designs require the user to connect and disconnect every single time there is a need to move their pull-cart to another location, which for some golfers may need to be done around 100 times per round. Additionally, being connected to a loaded pull-cart could cause injury to the user if the pull-cart goes out of control for any reason.

### BRIEF SUMMARY OF THE INVENTION

A device attached to a wheeled pull-cart that transmits forward motion from the user through his/her waist. When the user is positioned in the large hook shaped frame, with one hand on the attached guide handle, and when beginning to walk towards the next destination, the user comes into contact with a flexible band (or strap) that spans the top half of the hook, and the pull-cart begins to move forward while following the direction of the user.

The forces transmitted into the hand placed on the guide handle are minimal because most pull-carts have an adjustable handle which allows the user to change the load center of gravity. This new invention is properly positioned by mechanically adjusting the existing handle end of the pull-cart to a level that first balances the pull-cart weight and second would comfortably be used for controlling the pull-cart with the user's hand. This also allows adaptation to many different sized users.

With this design, most of the force required to move the pull-cart is transmitted from the user's waist through a flexible band (or strap) that spans the open top of the hook shaped frame. The elasticity of this band absorbs surges that occur in normal walking, and returns this energy when it rebounds, which helps maintain contact between the user and the pull-cart thereby enhancing control. The elasticity of this band also buffers impact forces from the pull-cart that would otherwise be felt through an inflexible interface.

### BRIEF DESCRIPTION OF THE SEVERAL VIEWS OF THE DRAWING

FIG. 1 shows the invention mounted to a common two-wheeled golf bag pull-cart (5a, in dashed lines, not a part of this claim) through a mechanical connection point (4a). It also shows the square or tubular metal hook-shaped frame (1a), and the tubular metal guide handle (3a), which is either mechanically attached or welded to the frame (1a). The flexible band (2a) is shown mechanically connected to the frame (1a). A commercially available non-slip handle grip (not part of this claim) is shown on the end of the guide handle (3a).

FIG. 2 shows the golf bag pull-cart (5a) in the rolling position, fitted with this invention, being towed by a user (6a, shown in outline) who is positioned in the middle of the hook-shaped frame (1a) and is holding the guide handle (3a), with his body making contact with the flexible band (2a) that is hidden by the user's arm and the frame.

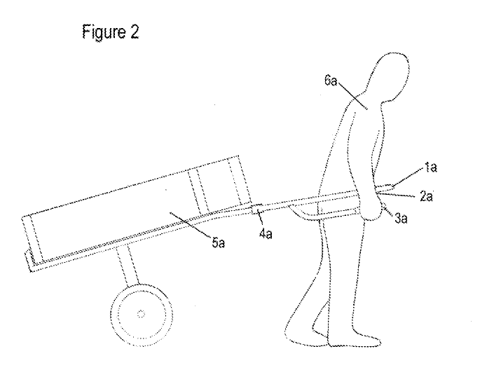

FIG. 3 shows the user's (6a) position in the main frame (1a), with his/her waist resting against the flexible band (2a).

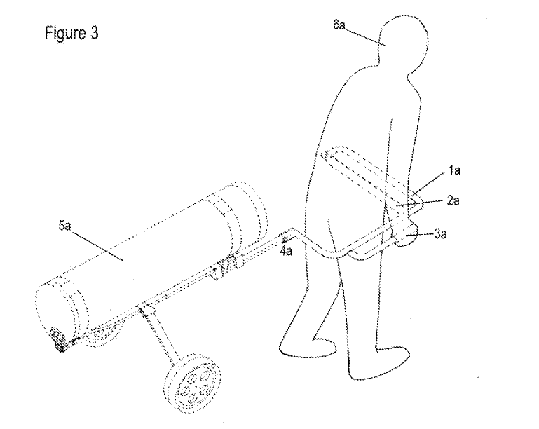

### DETAILED DESCRIPTION OF THE INVENTION

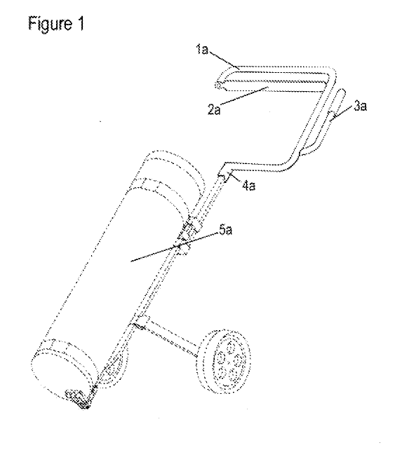

Part 1a, as shown in FIG. 1, is a frame of square or round metallic tubing which is formed into a hooked shape (somewhat resembling a question mark) that will allow a user to walk inside of the hook and will allow the frame extension behind the user to be attached to a pull-cart.

Part 2a, as shown in FIG. 1, is a flexible strap extending from the left side to the right side of the hook shaped frame (1a) and is attached to the frame at both ends in a way that will provide an appropriate level of stiffness necessary when the user walks forward and presses against it with his/her waist.

Part 3a, as shown in FIG. 1, is a guide handle of round metallic tubing with a bend to allow attachment by mechanical means or welding to the frame (1a) so that the user's hand can grasp it and thereby guide the golf bag pull-cart. The guide handle grip is a standard bicycle part and is not a part of this claim.

Part 4a, as shown in FIG. 1, is the point at which this invention can be integrated into a pull cart design, or a mechanical arrangement to attach the frame (1a) to an existing pull-cart. This mechanical attachment device is not a part of this claim.

While FIG. 1 and the foregoing description depicts the use of the invention by right-handed users it should not limit the scope of the invention when a mirror image configuration is used for left-handed users.

I claim:

1. A pull-cart handle that is made from a large hooked shaped square or tubular metal frame with a guide handle bar attached to it by welding or mechanical means and with a flexible band (or strap) extending from one side of the frame to the other.
